(19) United States
(12) Patent Application Publication
(10) Pub. No.: US 2020/0324982 A1
(43) Pub. Date: Oct. 15, 2020

(54) APPARATUS FOR TRANSFERRING CONTAINERS AND THEIR CONTENTS, AND METHODS OF MAKING AND USING THE SAME

(71) Applicant: Abraham WIEBE, Kingsburg, CA (US)

(72) Inventor: Abraham WIEBE, Kingsburg, CA (US)

(73) Assignee: DMM Packaging, Inc., Kingsburg, CA (US)

(21) Appl. No.: 16/845,724

(22) Filed: Apr. 10, 2020

Related U.S. Application Data
(60) Provisional application No. 62/832,169, filed on Apr. 10, 2019.

(51) Int. Cl. B65G 47/90; B25J 9/00

(52) U.S. Cl. CPC B65G 47/902; B65G 49/061; B25J 9/0093

(57) ABSTRACT

An apparatus that includes a clamp configured to secure one or more containers, a conveyor, a housing, a mechanism configured to raise or lower the clamp and the container(s), and a connector is disclosed. The conveyor or other object or structure has a planar surface configured to cover the container(s). The housing encloses the clamp and is configured to house and/or mechanically support the conveyor or other object or structure. The mechanism is configured to raise or lower the clamp and the container(s) relative to the conveyor or other object or structure. The connector is configured to connect or couple the apparatus to a robotic arm. Methods of making and using the apparatus are also disclosed.

### RELATED APPLICATION

The present application claims priority to U.S. Provisional Pat. Appl. No. 62/832,169, filed Apr. 10, 2019 (Atty. Docket No. DMM-001-PR), incorporated herein by reference in its entirety.

### FIELD OF THE INVENTION

The present invention generally relates to the field of apparatuses for transferring containers and products therein from a stack of such containers, and optionally restacking the containers, and methods of making and using such apparatuses.

### DISCUSSION OF THE BACKGROUND

In many industries, there is a need for a quick and efficient method to safely remove various products (e.g., fruits and vegetables) from a stack of containers. In many current processes, multiple people working in shifts pick up each container in the stack one at a time and flip them onto a conveyor (e.g., a belt with rollers). Thus, there is a need for a method to unload multiple containers simultaneously, quickly and efficiently without damaging the sensitive products inside the containers.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

To solve the above problem(s), a destacker apparatus (e.g., tool) may transfer multiple containers and empty them with minimal kinetic impact to the product(s) therein. The destacker apparatus may secure multiple containers (e.g., from a stack of containers) with a clamping mechanism, lift the containers, and rotate the containers 180° (e.g., so that the containers are flipped upside down). During the rotation, the containers are pressed or held against a conveyor (a conveyor belt or another structure having a flat, relatively inflexible surface) inside the destacker apparatus, which limits the distance the product(s) can move and reduces the possibility of damage. Once the containers and the product(s) have been flipped, the containers are lifted away from the conveyor, leaving the product(s) safely on the conveyor or other surface. The products are held in place by side walls or guides alongside the conveyor or flat surface. The product(s) may now be transferred easily and safely to the next process. Once the product(s) have been removed from the destacker apparatus (e.g., onto another conveyor external to the destacker apparatus), the robot arm is moved to a designated position where the empty containers are then stacked, and the method may be repeated for other containers in the original stack.

Thus, in one aspect, the present invention relates to an apparatus, comprising a clamp configured to secure one or more containers, a conveyor or other object or structure having a planar surface configured to cover the container(s), a housing enclosing the clamp and configured to house and/or mechanically support the conveyor or other object or structure, a mechanism configured to raise or lower the clamp and the container(s) relative to the conveyor or other object or structure, and a connector configured to connect or couple the apparatus to a robotic arm.

In various embodiments, the conveyor or other object or structure comprises a flat, inflexible surface. Alternatively, the conveyor or other object or structure may comprise a conveyor belt on a plurality of rollers, supported by a frame or support.

In other or further embodiments, the connector is secured or affixed to an outer surface of the frame or support, and/or the clamp is secured or affixed to an inner surface of the housing. The housing may include side walls or guides configured to keep articles or objects on the conveyor (or the planar surface of the other object or structure) when the mechanism raises the clamp and the container(s).

In various embodiments, the mechanism configured to raise or lower the clamp and the container(s) includes one or more hydraulics, pneumatics, or motors. In other or further embodiments, the clamp may be configured to secure a plurality of containers.

In another aspect, the present invention relates to a method of transferring articles or objects in one or more containers, comprising securing the container(s) in a first location with a clamp, pressing or holding the container(s) against a planar surface of a conveyor or other object or structure, rotating the apparatus by more than 90° using a robotic arm while the container(s) are pressed or held against the planar surface of the conveyor or other object or structure to invert the container(s), transferring the container(s) near or adjacent to a second location (to which the articles or objects in the container[s] are to be transferred) using the robotic arm, raising the clamp and the container(s), and transferring the articles or objects of the container(s) to the second location. The clamp and the conveyor or other object or structure having a planar surface are in an apparatus configured to transfer the articles or objects from the container. The apparatus is attached or connected to the robotic arm.

In one embodiment, the apparatus is rotated by about 180°. However, the apparatus can be rotated by other angles or arcs (i.e., any angle or arc that the rotating arm can rotate the apparatus). For example, in some embodiments, a flat surface or another container is at the second location. In such embodiments, the method may further comprise orienting the apparatus so that the conveyor or other object or structure is aligned with the flat surface or the other container.

In further embodiments, the method may be repeated until the articles or objects of an entire stack of containers (including the one or more containers) have been transferred to the second location. In other or further embodiments, the clamp and the one or more containers may be raised using one or more hydraulics, pneumatics, or motors.

As for the present apparatus, the conveyor or other object or structure may comprise a flat, inflexible surface, or alternatively, a conveyor belt on a plurality of rollers, supported by a frame or support. Similarly, in some embodiments, the clamp is attached, secured or affixed to a housing in the apparatus. In such embodiments, the conveyor or other object or structure may be in the housing, and the housing may include side walls or guides configured to keep the articles or objects on the conveyor or the planar surface of the other object or structure.

Thus, the present invention meets the need for a quick and efficient method to safely remove various easily-damaged articles or objects (e.g., fruits and vegetables) from a stack of containers, while reducing risk of injury to people lifting or flipping the container(s), and reducing labor costs. The present apparatus and method(s) unload containers quickly and efficiently without damaging the sensitive products therein. These and other advantages of the present invention will become readily apparent from the detailed description of various embodiments below.

### BRIEF DESCRIPTION OF THE DRAWINGS

FIG. 1A is a diagram showing an exemplary destacker apparatus connected to a robotic arm and securing multiple containers, in accordance with one or more embodiments of the present invention.

FIG. 1B is a diagram showing a cross-section of the destacker apparatus shown in FIG. 1A along the line A-A, in accordance with one or more embodiments of the present invention.

FIG. 2A is a diagram showing the destacker apparatus of FIGS. 1A-B after rotating the containers.

FIG. 2B is a diagram showing a cross-section of the destacker apparatus in FIG. 2A along the line B-B.

FIG. 3A is a diagram showing the destacker apparatus of FIGS. 1A-2B after separating the housing from the conveyor so that the products in the containers may be transferred.

FIG. 3B is a diagram showing a cross-section of the destacker apparatus shown in FIG. 3A along the line C-C.

FIGS. 4A-G are diagrams showing the exemplary destacker apparatus of FIGS. 1A-3B on a robotic arm in an exemplary method of destacking multiple containers and transferring the contents of the containers to an external conveyor, in accordance with one or more embodiments of the present invention.

FIG. 5 is a flowchart describing a method of using the destacker apparatus (e.g., as shown in FIGS. 4A-G), in accordance with one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

In various embodiments, a robotic arm mounts the top of the destacker apparatus, where it is able to move the destacker apparatus into any position within its reach. The robotic arm mount is attached to a housing containing a conveyor or other transfer surface. The conveyor housing (which may house or secure a clamp therein that grips the containers) moves up and down in relation to the conveyor. With the ability to move the conveyor to sit against the openings of the containers, the product (in the containers) remains isolated and does not fall out of the containers when the apparatus is moved to an inverted position. The clamp in the housing can hold one or multiple containers through the transition from an original position to a final position.

An Exemplary Destacker Apparatus

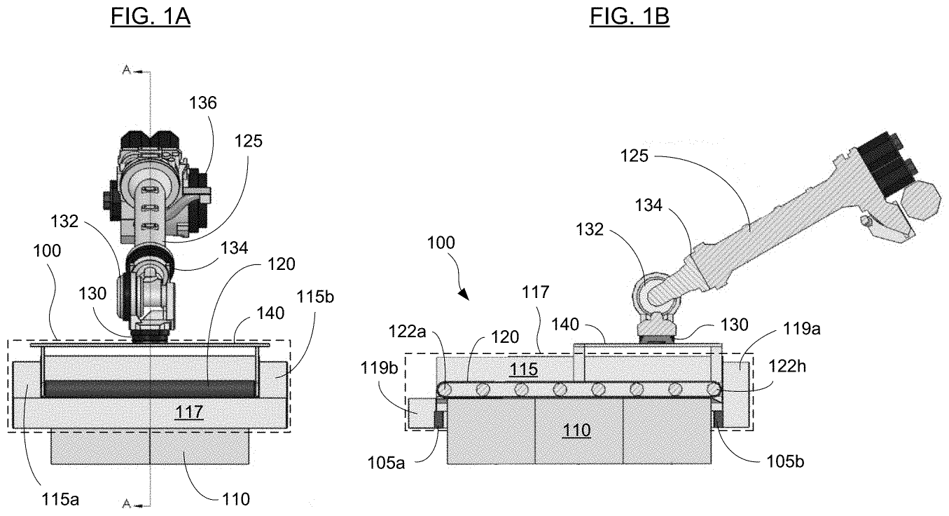

FIGS. 1A-B are diagrams showing an exemplary destacker apparatus 100. FIG. 1B shows a cross-section of the destacker apparatus 100 along the line A-A in FIG. 1A. The exemplary destacker apparatus 100 may comprise a housing 117 with sidewalls or guides 115a-b. The housing 117 may house a conveyor 120 (which may include a conveyor belt on two or more rollers 122a-h and a motor [not shown] configured to rotate at least one of the rollers 122 to drive the conveyor belt) and a clamp 105a-b configured to secure one or more containers 110 within the sidewalls 115. In alternative embodiments, the conveyor 120 may be replaced with an object or structure having a flat, relatively inflexible surface (e.g., a plywood, aluminum, or plastic [e.g., high-density polyethylene (HDPE), polycarbonate, etc.] sheet) for use with transferring round articles or objects (or other articles or objects that can move on a sloped surface under the force of gravity).

The housing 117 comprises materials sufficiently thick, stiff and strong to perform the functions described herein. Suitable examples of such materials include plywood (e.g., having a thickness of at least 0.5 inches or 1.25 cm), plastic (e.g., HDPE or a polycarbonate having a thickness of at least 0.625 inches or 1.5 cm), or metal (e.g., aluminum or steel having a thickness of at least 0.125 inches or 0.25 cm). The housing 117 may further comprise an end wall 119a having a height similar or equal to that of the sidewalls 115. Alternatively, the uppermost surface of the end wall 119a as shown in FIG. 1B may be coplanar or nearly coplanar with the uppermost surface of the sidewalls 115. The sidewalls 115 and the end wall 119a enclose the conveyor 120 and generally extend above the conveyor 120. For example, the sidewalls 115 and the end wall 119a may extend at least 6 inches (15 cm) above the conveyor 120, or any minimum distance greater than 6 inches (e.g., 8 inches or 20 cm, 12 inches or 30 cm, etc.). The end wall 119b may have an uppermost surface below the uppermost surface of the conveyor 120, or be entirely below the conveyor 120, such that the housing 115 effectively has an open end at an end of the conveyor 120.

The housing 117 generally has dimensions effective to enclose the conveyor 120 and the upper or open ends of the containers 110. In some embodiments, the sidewalls 115a-b and optionally one or both end walls 119a-b may comprise double-walled structures, with a space or enclosure between the two walls for hydraulics, pneumatics, motors, etc., as discussed herein. In such embodiments, one of the two walls may include a door, hatch or other (optionally closeable) opening configured to allow access to one or more of the hydraulics, pneumatics, motors, etc.

The clamp 105a-b may comprise one or more pairs of opposing braces, brackets or similar structures mounted on the interior surfaces of end walls 119a-b and/or sidewalls 115a-b, configured to reversibly apply pressure to sides of the containers 110. Alternatively, when the containers 110 have outwardly-extending upper lips or edges along their uppermost surfaces or edges, the clamp 105a-b may simply comprise an extendable and retractable structure configured to support the upper lips or edges of the containers 110, without necessarily applying a force to the sides of the containers 110. Each of the clamp sections 105a-b may comprise two or more colinear pieces, rather than a single section. Each clamp section 105 may comprise wood (e.g., a standard 2″×4″, 2″×6″, or 2″×8″ having a length less than the width of the interior of the housing 117), metal (e.g., aluminum or steel), or plastic (e.g., HDPE), and may be covered on at least the interior-facing surface and optionally the upward-facing surface with a padding such a cloth, foam rubber, etc. The clamp sections 105a-b may thus have dimensions of from 12 inches (30 cm) to 60 inches (150 cm) in length, 2 inches (5 cm) to 12 inches (30 cm) in width, and 0.25 inch (0.6 cm) to 4 inches (10 cm) in thickness, or any value or range of values therein, although other values are certainly possible.

The clamp sections 105a-b may be driven (e.g., extended and retracted) by one or more hydraulics, pneumatics, motors, or similar reversible mechanism configured to extend and retract the clamp section 105 a short distance (e.g., about 1-10 cm). Alternatively, the clamp sections 105a-b may be spring-loaded, and the housing 117 may have one or more levers fixed thereto to retract (e.g., load) the spring(s) and one or more clips or other retaining mechanisms to hold the clamp section in place after retracting the spring(s).

The conveyor 120 may comprise a belt suspended on a plurality of rollers 122a-h. The conveyor 120 may have length and width dimensions similar to or slightly smaller than those of the interior of the housing 117. The rollers 122a-h may have a diameter of 1-8 inches (2.5-20 cm), although they are not so limited. The rollers 122a-h may be mounted on a separate frame or similar support (not shown) within the interior of the housing 117. In some embodiments, the frame or support for the rollers 122a-h is not fixed to the walls of the housing 117 to which the clamp 105 is attached. For example, the frame or support for the rollers 122a-h may be fixed to or mounted on the end walls 119a-b, and the clamp 105 may be fixed or attached to the side walls 115a-b. At least one of the rollers 122a-h may be rotationally driven by a variable-speed motor (not shown) at a relatively low speed (e.g., up to about 100 rpm), so that the belt advances at a maximum rate or velocity of about 10-20 feet/min (about 3-6 m/min).

Alternatively, the conveyor 120 may comprise a flat, inflexible surface, such as plywood, metal or plastic as described herein. The inflexible surface should have a stiffness or an elastic modulus (e.g., Young's modulus, shear modulus, or bulk modulus) sufficient to support the weight of the articles or objects in the container(s) 110 without significant deformation, and be configured so that the articles or objects in the container(s) 110 roll or slide down it when it is tilted or angled.

The destacker apparatus 100 may be connected to a robotic arm 125 through a mount or connector 130 connected or affixed to a frame 140 that supports the conveyor 120. The mount or connector 130 may freely rotate to allow the destacker apparatus 100 to position and/or align the container(s) 110 as desired (e.g., in a two-dimensional plane).

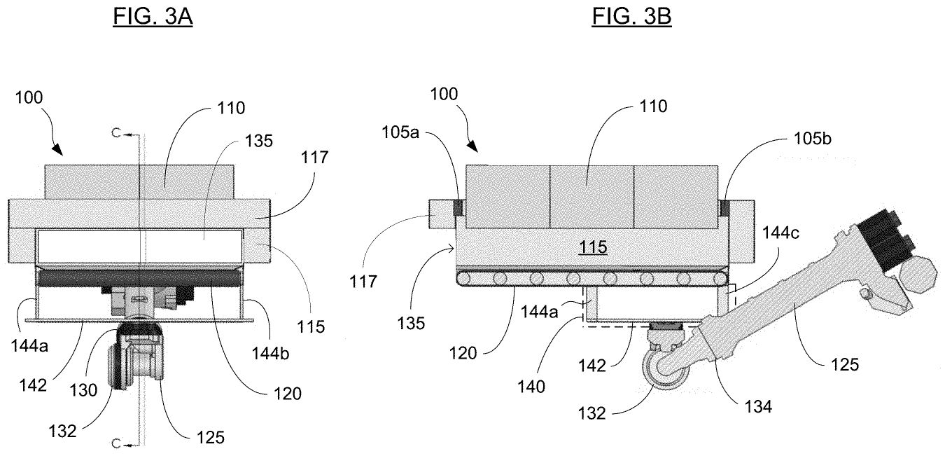

As shown in FIGS. 3A-B, the frame 140 may comprise a substantially lateral interface portion 142 and a plurality of substantially orthogonal supports or legs 144a-c joined or affixed thereto. The robotic arm connector 130 may be affixed or attached to a center of the substantially lateral interface portion 142. The substantially orthogonal supports or legs 144a-c are joined, affixed or attached at the opposite end to the conveyor 120 or a separate frame or support therefor. Alternatively, the supports or legs 144a-c may be joined, affixed or attached to the mechanism that lifts the housing and sidewalls 115/117 relative to the conveyor 120 and/or the frame 140 (see the discussion below).

In some embodiments, the connector 130 comprises a first connecting portion affixed or attached to the substantially lateral interface portion 142, and a second, complementary and/or mating connecting portion affixed or attached to the robotic arm 125. The first and second connecting portions of the connector 130 connect to each other in a manner enabling the apparatus 100 to be securely joined to the robotic arm 125, and for the apparatus 100 to rotate around an axis orthogonal to the center of the connector 130. The connector 130 is generally conventional, and will not be described in greater detail herein.

The substantially lateral interface portion 142 may comprise a relatively flat or planar sheet of inflexible material, such as plywood (e.g., at least 0.75 inches [2 cm] thick), metal (e.g., aluminum at least 0.25 inches [0.6 cm] thick, steel at least 0.125 inches [0.3 cm] thick, etc.), plastic (e.g., HDPE or polycarbonate at least 0.5 inches [1.25 cm] thick), or a combination thereof. The substantially lateral interface portion 142 may have a width the same as or smaller than the width of the interior of the housing 117 and a length of from 50-100% of the length of the interior of the housing 117. The width of the substantially lateral interface portion 142 may be at least 90% or 95% of the width of the interior of the housing 117.

The frame 140 may comprise four (4) supports or legs 144a-c (the fourth support or leg is not visible in FIGS. 3A-B), each of which is orthogonal to and joined, affixed or attached to the substantially lateral interface portion 142 at a corner of the substantially lateral interface portion 142. However, other numbers of supports or legs 144a-c may be present (e.g., 6, 8, etc.). The supports or legs 144a-c may have a length sufficient for the robotic arm 125 to safely and easily connect to the connector 130, without contacting any of the sidewalls 115 or the end wall 119a. For example, the supports or legs 144a-c may have a length of 6-30 inches (15-75 cm) and a width of 1-6 inches (2.5-25 cm), although the invention is not so limited. The material of the supports or legs 144a-c (and the thickness[es] thereof) may selected from those described for the substantially lateral interface portion 142, and in some cases, the material of the supports or legs 144a-c is the same as that of the substantially lateral interface portion 142.

Alternatively, the frame 140 may comprise a unitary piece, comprising a central connecting portion (joined to the connector 130) and a plurality of curved or angled legs connecting the central connecting portion to the conveyor 120 (or frame or support therefor) or the mechanism for lifting the housing and sidewalls 115/117 relative to the conveyor 120 and/or the frame 140. The shape and dimensions of the legs can be substantially any shape or dimension, as long as the legs do not interfere with the movement of the articles or products on the conveyor 120 after the containers 110 are flipped over and the housing and sidewalls 115/117 are raised or lifted relative to the conveyor 120 and/or the frame 140.

The robotic arm 125 is configured to rotate and translate the destacker apparatus 100. The robotic arm 125 is able to move freely in 3 rotational degrees of freedom, and in some embodiments, one or more linear degrees of freedom. For example, the robotic arm 125 may include one or more rotating joints 132, 134 and 136, configured to rotate at least part of the robotic arm 125 around an axis and/or within a two-dimensional plane. A first rotating joint 132 is configured to rotate the mount or connector 130 around an axis perpendicular to the axis around which the mount or connector 130 rotates and parallel with the two-dimensional plane in which the destacker apparatus 100 rotates. A second rotating joint 134 is configured to rotate the mount or connector 130 and the first rotating joint 132 around an axis parallel or coaxial with a central axis of the main body of the robotic arm 125. A third rotating joint 136 is configured to raise and lower the main body of the robotic arm 125 by rotation around an axis parallel with a horizontal two-dimensional plane (e.g., the ground). In some embodiments, the main body of the robotic arm 125 includes a telescoping mechanism configured to extend and retract at least the mount or connector 130 and the first rotating joint 132 (and, optionally, the second rotating joint 134). The robotic arm 125 can move the destacker apparatus 100 to any position substantially within reach.

The destacker apparatus 100 may secure one or more containers 110 (e.g., from a stack of containers) using the clamp 105a-b. As shown, six containers 110 are arranged in a 2-by-3 matrix. However, other arrangements of containers are possible, such as 2-by-2, 1-by-3, 2-by-4, etc. (i.e., an x-by-y matrix of containers, where one of x and y is an integer of at least 1, and the other of x and y is an integer of at least 2). The destacker apparatus 100 may also secure a single container 110. The containers 110 may have dimensions of from 18 inches (45 cm) to 60 inches (150 cm) in length, 9 inches (22.5 cm) to 36 inches (90 cm) in width, and 6 inches (15 cm) to 36 inches (90 cm) in depth, or any value or range of values therein, although other values are certainly possible. Similarly, the containers 110 can be square or rectangular (e.g., when viewed from the top or bottom), but other shapes are acceptable (e.g., circular, oval, hexagonal, octagonal, etc.), as long as the claim 105a-b has an interface that complements or mates with the shape of the container(s) 110. The containers 110 are generally open at the top, and may include articles or objects, such as food product(s) (e.g., fruits or vegetables), therein.

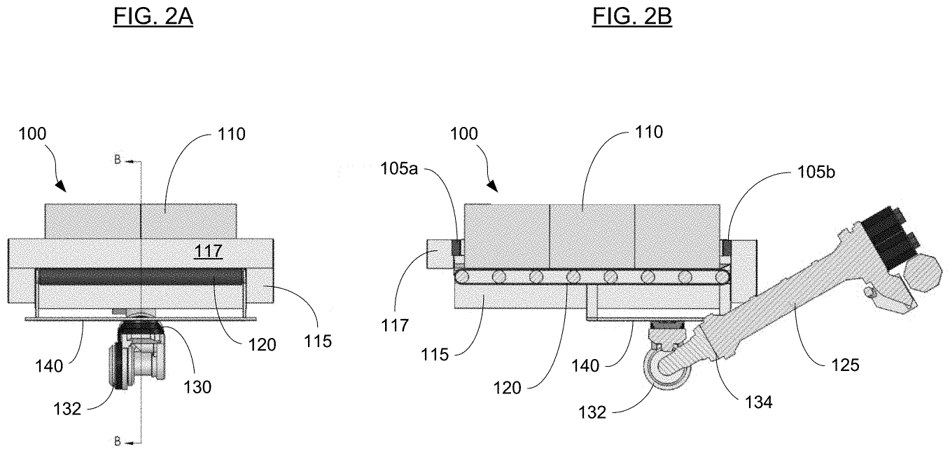

FIGS. 2A-B are diagrams showing the destacker apparatus 100 after being rotated 180° such that the containers 110 are flipped upside down. For example, after the containers 110 are clamped using the clamp 105a-b and lifted by the robotic arm 125, the robotic arm 125 may rotate the second rotating joint 134 by 180° to flip the containers 110 upside down. FIG. 2B shows a cross-section of the destacker apparatus 100 along the line B-B in FIG. 2A. The open ends (e.g., uppermost surfaces) of the containers 110 are against the belt of the conveyor 120. The articles or product(s) in the containers 110 may be pressed or held against the conveyor 120 due to gravity and kept on the conveyor 120 by the sidewalls or guides 115 (e.g., after lifting the containers 110 away from the conveyor 120).

FIGS. 3A-B are diagrams showing the destacker apparatus with the housing 117, the clamp 105a-b, and the containers 110 in a raised position. FIG. 3B shows the cross-section of the destacker apparatus 100 along the line C-C in FIG. 3A. The housing and sidewalls 115/117 are separated from the conveyor 120 such that an opening 135 appears in the apparatus 100. The housing and sidewalls 115/117 may be separated from the conveyor 120 using one or more hydraulics, pneumatics, motors, or other mechanisms for lifting the housing and sidewalls 115/117 relative to the conveyor 120 and/or the frame 140, such that the sidewalls 115 remain alongside the conveyor 120. The product(s) in the containers 110 may then be conveyed by the conveyor 120 through the opening 135 onto a surface (e.g., a conveyor belt or other surface external to the destacker apparatus 100).

For example, a mechanism for lifting the housing and sidewalls 115/117 relative to the conveyor 120 and the frame 140 may comprise a hydraulic or pneumatic cylinder and/or piston having one end secured to the frame 140 or a frame or support for the conveyor 120 and another (opposite) end within and/or secured to one of the sidewalls 115a-b or end walls 119a-b. The hydraulic or pneumatic cylinder and/or piston may be extended and retracted conventionally. In some embodiments, the mechanism for lifting the housing and sidewalls 115/117 relative to the conveyor 120 and the frame 140 comprises two such hydraulic or pneumatic cylinders and/or pistons, secured to opposite sides of the frame 140 or frame/support for the conveyor 120, and to opposite sidewalls 115a-b or end walls 119a-b. in other embodiments, the mechanism for lifting the housing and sidewalls 115/117 relative to the conveyor 120 and the frame 140 comprises four hydraulic or pneumatic cylinders and/or pistons, secured to opposite sides and ends of the frame 140 or frame/support for the conveyor 120, and to opposite sidewalls 115a-b or end walls 119a-b at or near opposite ends thereof.

Alternatively, one or more motors may operate a mechanical device for lifting the housing and sidewalls 115/117 relative to the conveyor 120 and the frame 140. The motor(s) may be secured in one or more one of the sidewalls 115a-b or end walls 119a-b, and the mechanical device(s) may be secured to the frame 140 or frame/support for the conveyor 120. For example, the motor may drive (extend) and retract the mechanical device using one or more conventional mechanisms (e.g., gears and toothed rods/shafts, cams and camshafts, etc.). Regardless of the specific mechanism for lifting the housing and sidewalls 115/117 relative to the conveyor 120 and the frame 140, the housing and sidewalls 115/117 may be lifted by a distance or height of from 6-40 inches (15-100 cm), or any distance/height or range of distances/heights therein, although the invention is not so limited.

An Exemplary Method of Transferring Articles or Objects from One or More Containers

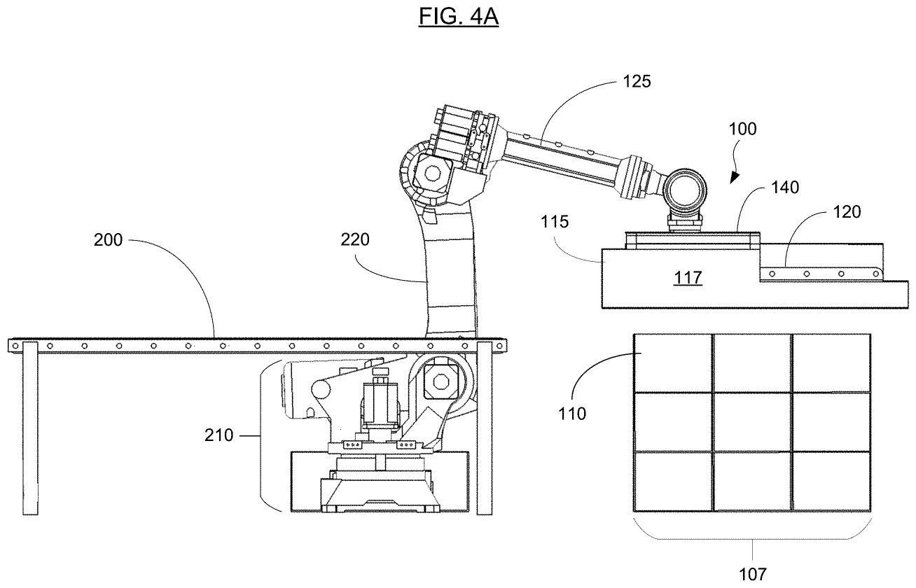

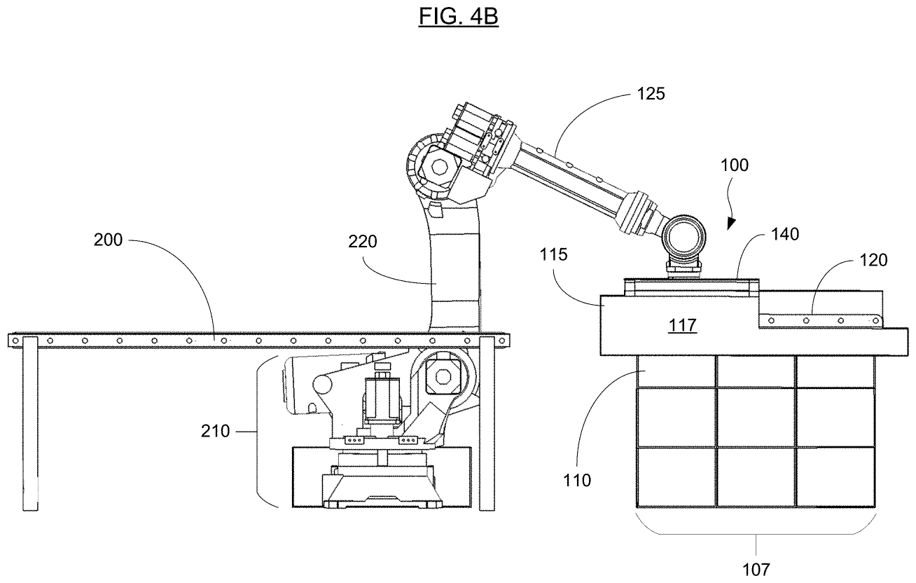

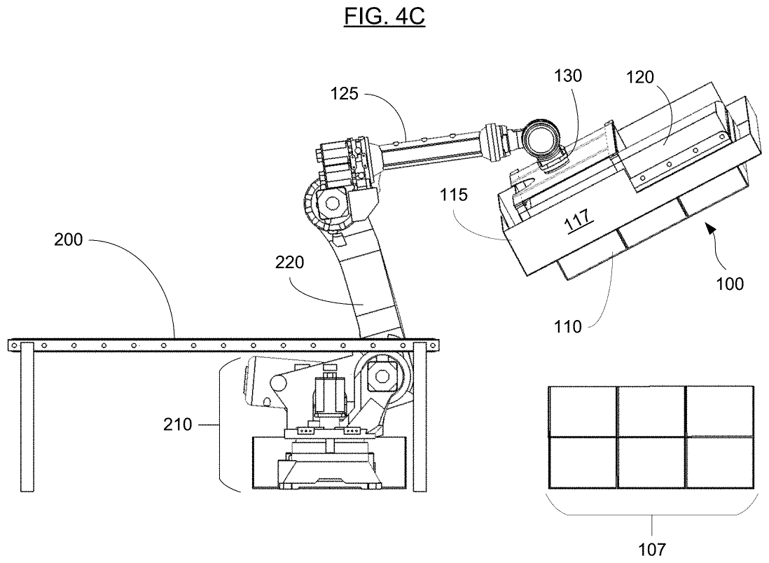

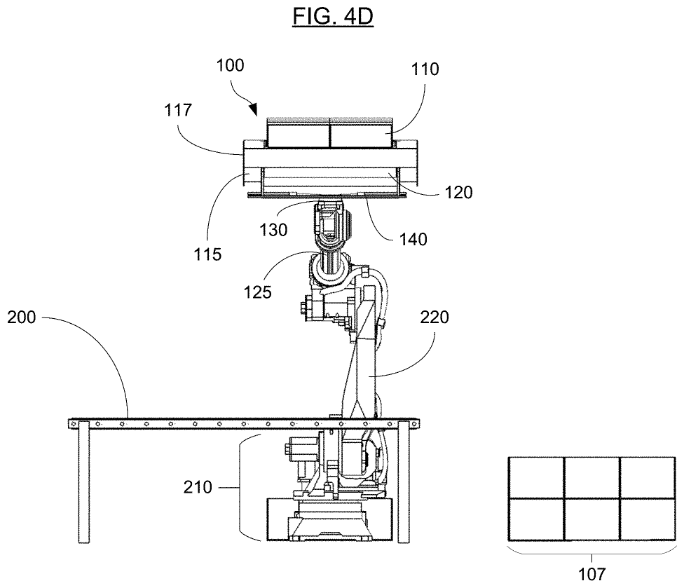

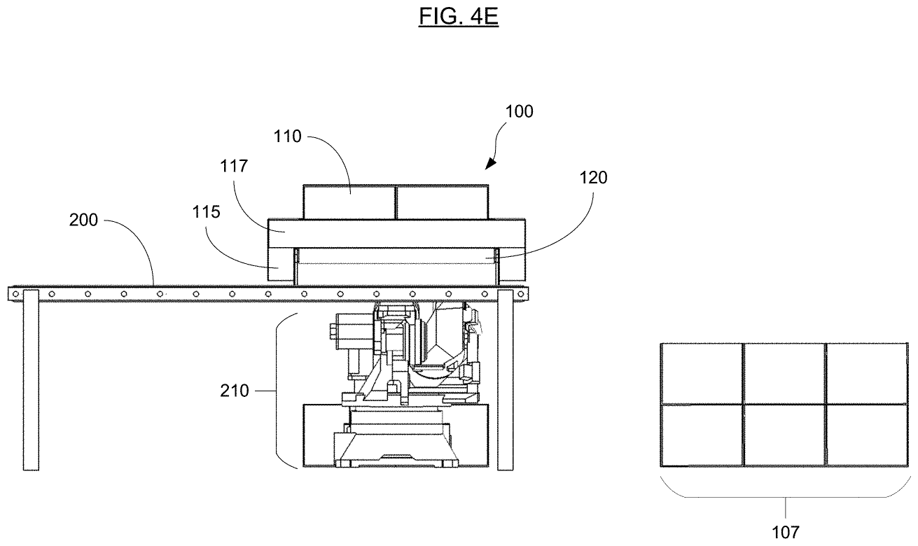

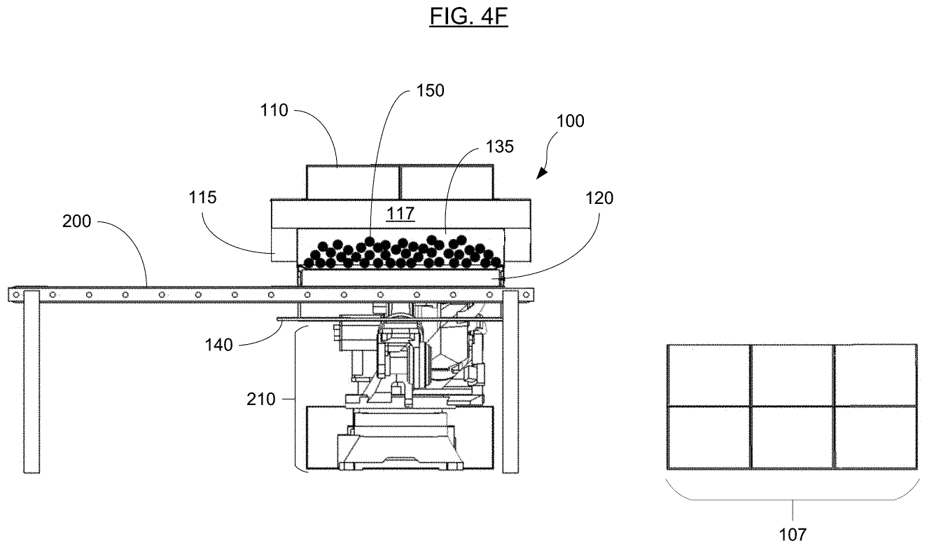

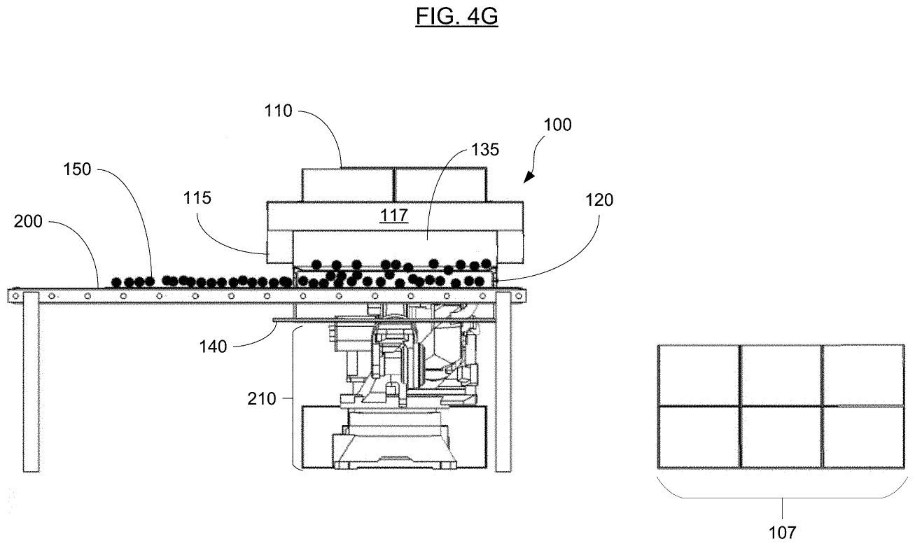

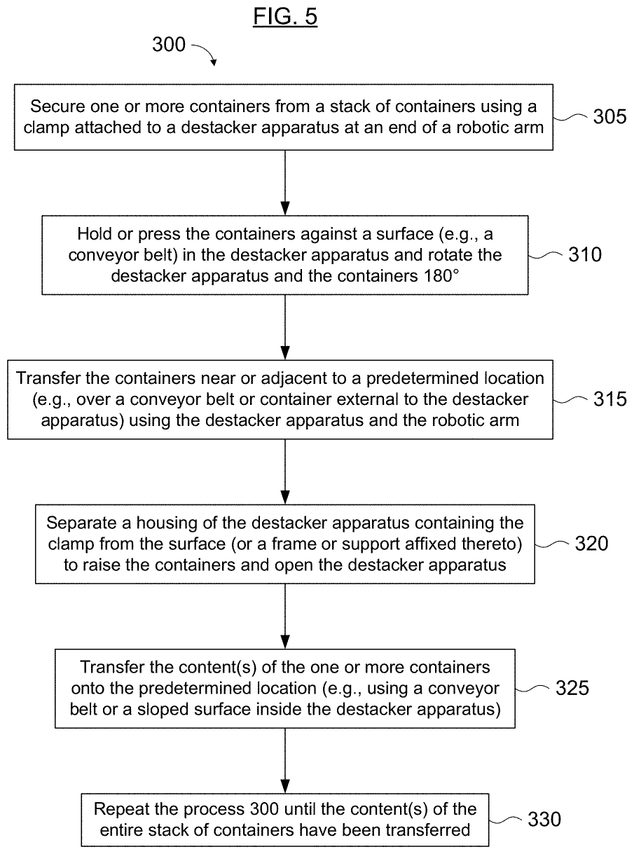

FIG. 5 is a flowchart describing a method of transferring articles or objects from one or more containers using the destacker apparatus 100. Each of the steps 305-330 are further illustrated in FIGS. 4A-G.

At step 305, one or more containers 110 are secured from a stack of containers 107 using the clamp 105a-b (shown in FIGS. 1B, 2B, and 3B) in the housing 117. FIG. 4A shows the destacker apparatus 100 positioned over the stack of containers 107. FIG. 4B shows the destacker apparatus 100 lowered onto the stack of containers 107 using the robotic arm 125, and an uppermost layer of containers 110 secured using the clamp 105a-b. The conveyor 120 contacts the uppermost surface of the uppermost layer of containers 110. A robotic lever 220 secured to a base and/or control section 210 enables the robotic arm 125 to move in additional degrees of freedom.

At step 310, the destacker apparatus 100 is rotated using the robotic arm 125 such that the containers 110 are rotated 180° and content(s) of the containers 110 contact the conveyor 120. FIG. 4C shows the destacker apparatus 100 and the containers 110 being lifted from the stack of containers 107 and being rotated by the robotic arm 125. FIG. 4D shows the destacker apparatus 100 after being flipped upside down or rotated 180° (around an axis defined by the robotic arm 125) and translated horizontally about 90° to another surface (e.g., an external conveyor 200) around an axis defined by the robotic lever 220. Other rotational amounts (e.g., from 120° to 240°) are suitable for the destacker apparatus 100 (e.g., to facilitate gravity-fed transfer of the products from the destacker apparatus 100 to another surface or container).

At step 315, the containers 110 are moved near or adjacent to a predetermined final location. FIG. 4E shows the location of the destacker apparatus 100 after being lowered to a position adjacent to or over an external conveyor 200.

At step 320, the housing 117 and the clamped containers 110 are raised (or separated from the conveyor 120 and/or conveyor frame 140) to open the destacker apparatus 100. The content(s) of the containers 110 are now ready to be conveyed or transferred out of the containers 110 through the opening 135. FIG. 4F shows the exposed product(s) 150 after the housing is raised. The robotic arm 125 can also orient the destacking apparatus 100 so that the conveyor 120 is aligned with the conveyor 200, and the products are transferred in the direction of movement of the conveyors 120 and 200. Alternatively, the sidewalls or guides 115 can be can be parallel with the plane of page in FIG. 4F, or the opening 135 can be orthogonal to the plane of the page.

At step 325, the product(s) 140 are transferred to the external conveyor 200 through the opening 135 using the conveyor 120 in the apparatus 100. In alternative embodiments, the conveyor 120 may be replaced with a relatively flat, inflexible surface instead, and the surface may be tilted (e.g., using the robotic arm 125 and/or robotic lever 220) such that the products 150 are transferred through the opening 130 by gravity (e.g., when the product[s] are articles or objects that can roll or self-translate, such as round articles or objects [e.g., oranges]). FIG. 4G shows the products 150 being transferred onto the external conveyor 200. The external conveyor 200 may then transfer the product(s) to a remote location or another (e.g., larger) container (e.g., on a track or other vehicle).

At step 330, the apparatus 100 is positioned over the stack of containers 107 once again, and steps 305-325 are repeated until all of the containers in the stack 107 are emptied of their content(s). Repeating the steps 305-325 may result in the containers in the stack 107 being restacked in a different location, generally in reverse order.

Exemplary Methods of Making an Apparatus Configured to Transfer Articles or Objects from One or More Containers to Another Location

The present invention also relates to a method of making the present apparatus (e.g., the destacker apparatus 100). This method may comprise attaching or affixing a clamp configured to secure one or more containers to an interior surface of a housing configured to house and/or mechanically support a conveyor or other object or structure having a planar surface configured to cover the container(s) and convey articles or objects in the container(s), operably attaching or affixing to the housing and to the conveyor or other object or structure a mechanism configured to raise or lower the clamp and the container(s) relative to the conveyor or other object or structure, and joining, affixing or attaching to the apparatus a connector configured to connect or couple the apparatus to a robotic arm. In some embodiments, the clamp may be configured to secure a plurality of containers.

As for the present apparatus, the conveyor or other object or structure in various embodiments of the method may comprise a flat, inflexible surface, or alternatively, a conveyor belt on a plurality of rollers, supported by a frame or support. In such embodiments, the connector may be secured or affixed to an outer surface of the frame or support. The materials and dimensions of the various structures in the housing, the conveyor, and the frame may be as described herein for the present apparatus.

The method may further comprise assembling the housing, which may comprise joining side walls or guides to opposite ends of at least one end wall. The side walls or guides and the end wall as generally as described herein. The side walls are configured to keep articles or objects on the conveyor (or the planar surface of the other object or structure) when the mechanism raises the clamp and the container(s).

As for the present apparatus, the mechanism configured to raise or lower the clamp and the container(s) in various embodiments of the method includes one or more hydraulics, pneumatics, or motors, as described herein. Thus, the method may comprise fixing, attaching or mounting the frame or support for the conveyor on or to the end walls of the housing, and fixing, mounting or attaching the clamp to or on the side walls of the housing. In other or further embodiments, the method may further comprise joining, affixing or attaching an end of the frame distal from the connector (e.g., orthogonal supports or legs 144a-c) to the conveyor, a separate frame or support therefor, or to the mechanism that lifts the housing and sidewalls relative to the conveyor and the frame.

The method may also comprise securing one end of the mechanism(s) for lifting the housing and sidewalls (e.g., a hydraulic or pneumatic cylinder and/or piston having) to the frame or to a separate frame or support for the conveyor, and securing another (opposite) end of the mechanism(s) within or to one of the sidewalls or end walls of the housing. Securing plural mechanisms for lifting the housing and sidewalls relative to the conveyor and the frame may comprise securing hydraulic or pneumatic cylinders and/or pistons, or motors and mechanical devices (as described herein), to opposite sides and ends of the frame or frame/support for the conveyor, and at or near opposite ends of the mechanisms to opposite sidewalls or end walls.

The method may also further comprise affixing or attaching a first connecting portion of the connector to the frame (e.g., substantially lateral interface portion 142), and affixing or attaching a second connecting portion to the robotic arm. The second connecting portion is complementary to and/or configured to mate with the first connecting portion. The first and second connecting portions of the connector are as described above for the present apparatus.

### CONCLUSION/SUMMARY

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An apparatus, comprising:
a clamp configured to secure one or more containers;
a conveyor or other object or structure having a planar surface configured to cover the one or more containers;
a housing enclosing the clamp and configured to house and/or mechanically support the conveyor or other object or structure;
a mechanism configured to raise or lower the clamp and the one or more containers relative to the conveyor or other object or structure; and
a connector configured to connect or couple the apparatus to a robotic arm.

2. The apparatus of claim 1, wherein the conveyor or other object or structure comprises a flat, inflexible surface.

3. The apparatus of claim 1, wherein the conveyor or other object or structure comprises a conveyor belt on a plurality of rollers, supported by a frame or support.

4. The apparatus of claim 3, wherein the connector is secured or affixed to an outer surface of the frame or support.

5. The apparatus of claim 1, wherein the clamp is secured or affixed to an inner surface of the housing.

6. The apparatus of claim 1, wherein the housing includes side walls or guides configured to keep article(s) or object(s) on the conveyor or the planar surface of the other object or structure when the mechanism raises the clamp and the one or more containers.

7. The apparatus of claim 1, wherein the mechanism includes one or more hydraulics, pneumatics, or motors.

8. The apparatus of claim 1, wherein the clamp is configured to secure a plurality of containers.

9. A method of transferring articles or objects in one or more containers, comprising:
securing the one or more containers in a first location with a clamp in an apparatus configured to transfer the articles or objects in the one or more containers to a second location, the apparatus further comprising a conveyor or other object or structure having a planar surface;
pressing or holding the containers against the planar surface of the conveyor or other object or structure;
rotating the apparatus by more than 90° using a robotic arm to which the apparatus is attached or connected while the one or more containers are pressed or held against the planar surface of the conveyor or other object or structure to invert the one or more containers;
transferring the one or more containers near or adjacent to the second location using the robotic arm;
raising the clamp and the one or more containers; and
transferring the articles or objects of the one or more containers to the second location.

10. The method of claim 9, wherein the apparatus is rotated by about 180°.

11. The method of claim 9, comprising repeating the method until the articles or objects of an entire stack of containers including the one or more containers have been transferred to the second location.

12. The method of claim 9, wherein the conveyor or other object or structure comprises a flat, inflexible surface.

13. The method of claim 9, wherein the conveyor or other object or structure comprises a conveyor belt on a plurality of rollers, supported by a frame or support.

14. The method of claim 9, wherein a flat surface or another container is at the second location.

15. The method of claim 14, further comprising orienting the apparatus so that the conveyor or other object or structure is aligned with the flat surface or the other container.

16. The method of claim 9, wherein the clamp is attached, secured or affixed to a housing in the apparatus.

17. The method of claim 16, wherein the conveyor or other object or structure is in the housing.

18. The method of claim 17, wherein the housing includes side walls or guides configured to keep the articles or objects on the conveyor or the planar surface of the other object or structure.

19. The method of claim 9, wherein the clamp and the one or more containers are raised using one or more hydraulics, pneumatics, or motors.

20. A method of making an apparatus configured to transfer articles or objects from one or more containers to another location, comprising:
attaching or affixing a clamp configured to secure the one or more containers to an interior surface of a housing configured to house and/or mechanically support a conveyor or other object or structure having a planar surface configured to cover the container(s) and convey articles or objects in the container(s);
operably attaching or affixing to the housing and to the conveyor or other object or structure a mechanism configured to raise or lower the clamp and the container(s) relative to the conveyor or other object or structure; and
joining, affixing or attaching to the apparatus a connector configured to connect or couple the apparatus to a robotic arm.
